(19) United States
(12) Patent Application Publication
(10) Pub. No.: US 2006/0089146 A1
(43) Pub. Date: Apr. 27, 2006

(54) Method and apparatus for controlling call routing when testing nodes of a network in which mobile services switching centers and serving GPRS support nodes are pooled

(75) Inventor: Daryl Gazzard, Alpharetta, GA (US)

Correspondence Address: GARDNER GROFF SANTOS & GREENWALD, P.C., 2018 POWERS FERRY ROAD, SUITE 800, ATLANTA, GA, 30339, US

(73) Assignee: Cingular Wireless, LLC

(21) Appl. No.: 11/126,766

(22) Filed: May 11, 2005

Related U.S. Application Data
(60) Provisional application No. 60/622,283, filed on Oct. 26, 2004.

(51) Int. Cl. H04Q 7/20

(52) U.S. Cl. 455/445; 455/423

(57) ABSTRACT

The present invention ensures that a tester's call for testing a MSC or SGSN when it is brought back on line will be routed to the proper MSC or SGSN to be tested. In accordance with one embodiment, a call from a tester is identified by, for example, comparing the international mobile subscriber identity (IMSI) or temporary mobile subscriber identity (IMSI) associated with the call with a list of IMSIs or TMSIs. If a match occurs, the BSC determines that the call is from a tester and causes the call to be routed to the MSC or SGSN being tested. In accordance with another embodiment, the location from which the tester's call is placed ensures that the tester's call will be routed to the MSC or SGSN that needs testing.

### CROSS-REFERENCE TO RELATED APPLICATIONS

The benefit of the filing date of U.S. provisional patent application Ser. No. 60/622,283, filed Oct. 26, 2004, is hereby claimed, and the specifications thereof are incorporated herein by this reference.

### BACKGROUND OF THE INVENTION

1. Field of the Invention

The present invention relates to wireless communications networks. More particularly, the invention relates to controlling routing of calls when testing nodes in wireless communications networks that pool mobile services switching centers (MSCs) and serving GPRS support nodes (SGSNs).

2. Description of Related Art

In wireless communications networks that do not use pooling of MSCs and SGSNs, each BSC is typically connected to a single MSC and to a single SGSN. FIG. 1 illustrates a block diagram of such a non-pooling network configuration. BSC 2 is connected to MSC 3 and to SGSN 4. BSC 5 is connected to MSC 3 and to SGSN 4.

In the network shown in FIG. 1, traffic to and from a mobile device (not shown), such as a cellular telephone, that is being served by BSC 2 will be routed to and from MSC 3 (for voice) and SGSN 4 (for data). Likewise, traffic to and from a mobile device that is being served by BSC 5 will be routed to and from MSC 3 (for voice) and SGSN 4 (for data).

As mobile devices move between the area served by the BSC 5 into the area served by BSC 6, as indicated by the arrow 9, any voice calls in process are handed over from MSC 3 to MSC 7 and any data calls in process are handed over from SGSN 4 to SGSN 8. One of the disadvantages of this configuration is that the handover process can cause a large time delay and generate signaling traffic and load. For example, when a mobile device that is engaged in a voice call is being served by BSC 5 and the mobile device moves in the direction of arrow 9 from an area being served by BSC 5 to an area being served by BSC 6, information stored at MSC 3 relating to the mobile device must be communicated from MSC 3 to the new MSC 7. The handover is not complete until this information has been communicated between the MSCs for a voice call or between the SGSNs for a data call. Communicating this information can delay the handover process and consumes bandwidth that might otherwise be available for handling more calls.

Another disadvantage of the non-pooling network configuration shown in FIG. 1 is that if an MSC or SGSN becomes isolated, such as when a software upgrade needs to be performed, or the MSC or SGSN fails, services are affected in the BSCs that are connected to them, and the services cannot be restored until the MSC or SGSN has been functionally restored.

One of the advantages of the non-pooling network configuration shown in FIG. 1 is that it is relatively easy to control call routing during testing of a node. For example, if MSC 3 has recently received a software upgrade and needs to be tested, the tester can direct a test call to BSC 2 or to BSC 5 and the call will be routed to MSC 3. There is no possibility that the test call will be routed to SGSN 4, MSC 7 or SGSN 8. This is not the case in network configurations that pool MSCs and SGSNs.

FIG. 2 illustrates a block diagram of a wireless network that implements a pooling configuration. Each BSC is aware of multiple MSCs and multiple SGSNs, as indicated by the lines connecting each of the BSCs to multiple MSCs and to multiple SGSNs. For example, BSC 11 is connected to MSC 12, MSC 16, SGSN 13 and SGSN 17, as indicated by lines 21, 22, 23 and 24. BSC 14 is also connected to MSC 12, MSC 16, SGSN 13 and SGSN 17, as indicated by lines 25, 26, 27 and 28. BSC 15 is also connected to MSC 12, MSC 16, SGSN 13 and SGSN 17, as indicated by lines 29, 31, 32 and 33. BSC 18 is also connected to MSC 12, MSC 16, to SGSN 13 and SGSN 17, as indicated by lines 34, 35, 36 and 37.

With the network configuration shown in FIG. 2, it is possible for calls to and from mobile devices being served by any BSC of the network to be shared across multiple MSCs and multiple SGSNs. One advantage of this network configuration is that it eliminates a significant amount of call signaling overhead and the associated time delay of handing over the call. For example, if a mobile device being served by BSC 14 is engaged in a voice call and the mobile device moves in the direction of arrow 41 from an area being serviced by BSC 14 to an area being serviced by BSC 15, there is no need for information relating to the mobile device to be communicated from MSC 12 to MSC 16, as would have been the case with the non-pooling configuration shown in FIG. 1.

The same is true for a data call. For example, if a mobile device being served by BSC 14 is participating in a data call, and the mobile device moves in the direction of arrow 41 from an area being served by BSC 14 to an area being served by BSC 15, there is no need for information relating to the mobile device to be communicated from SGSN 13 to SGSN 17, as would have been the case with the configuration shown in FIG. 1. This is because BSC 14 is already connected to both SGSN 13 and to SGSN 17. Therefore, the configuration shown in FIG. 2 reduces call signaling overhead and time delay normally associated with handing over a data call from one SGSN to another.

With the pooling configuration shown in FIG. 2, if an MSC or SGSN fails or becomes isolated for some reason, then calls in progress may fail, but all subsequent calls will be routed to a working MSC or SGSN. For example, if a mobile device engaged in a voice call is being served by BSC 11 and MSC 12, and MSC 12 fails, BSC 11 can continue to serve calls by routing them to MSC 16.

One of the disadvantages of the pooling network configuration shown in FIG. 2 is that it is difficult to ensure that a test call will be routed to the node that needs to be tested. BSCs run distribution/scheduling algorithms that perform load sharing and other tasks. Calls being served by a given BSC are routed to different MSCs and SGSNs depending on the loads of the MSCs and SGSNs. Therefore, if, for example, a tester attempts to test MSC 12 by directing a call to BSC 11, it is possible that the call will be routed to MSC 16.

A need exists for a way to ensure that a test call will be routed to the proper node to be tested in network configuration that pools MSCs and SGSNs.

### SUMMARY OF THE INVENTION

The present invention provides a method and apparatus for routing test calls to a node that needs to be tested in a wireless network. In accordance with one embodiment, the apparatus comprises logic that is in a base station controller (BSC). The BSC is connected to at least two mobile services switching centers (MSCs). Calls serviced by the BSC can be routed to and from either or both of the MSCs. The logic in the BSC is configured to determine whether or not a call being served by the BSC is from a tester. If the logic determines that the call is from a tester, the logic causes the BSC to route the tester's call to a particular one of the MSCs for testing of the particular MSC.

In accordance with another embodiment, the BSC is connected to at least two serving global packet radio service (GPRS) support nodes (SGSNs). Calls serviced by the BSC can be routed to and from either or both of the SGSNs. The logic in the BSC is configured to determine whether or not a call being served by the BSC is from a tester. If the logic determines that the call is from a tester, the logic causes the BSC to route the tester's call to a particular one of the SGSNs for testing of the particular SGSN.

The method for testing nodes of a network, in accordance with one embodiment, comprises receiving calls in a BSC, identifying one of the calls as a test call, and routing the test call to a MSC to be tested.

The method for testing nodes of a network, in accordance with another embodiment, comprises receiving calls in a BSC, identifying one of the calls as a test call, and routing the test call to a SGSN to be tested.

These and other features and advantages of the invention will become apparent from the following description, drawings and claims.

### BRIEF DESCRIPTION OF THE DRAWINGS

FIG. 1 illustrates a block diagram of a known wireless non-pooling network configuration in which each BSC is connected to only one MSC and to one SGSN.

FIG. 2 illustrates a block diagram of a known wireless pooling network configuration in which each BSC is connected to multiple MSCs and to multiple SGSNs.

FIG. 3 illustrates a flow chart that represents the method of the invention in accordance with one exemplary embodiment for testing a node when it is brought back on line.

FIG. 4 illustrates a flow chart that represents the method of the invention in accordance with another exemplary embodiment for testing a node when it is brought back on line.

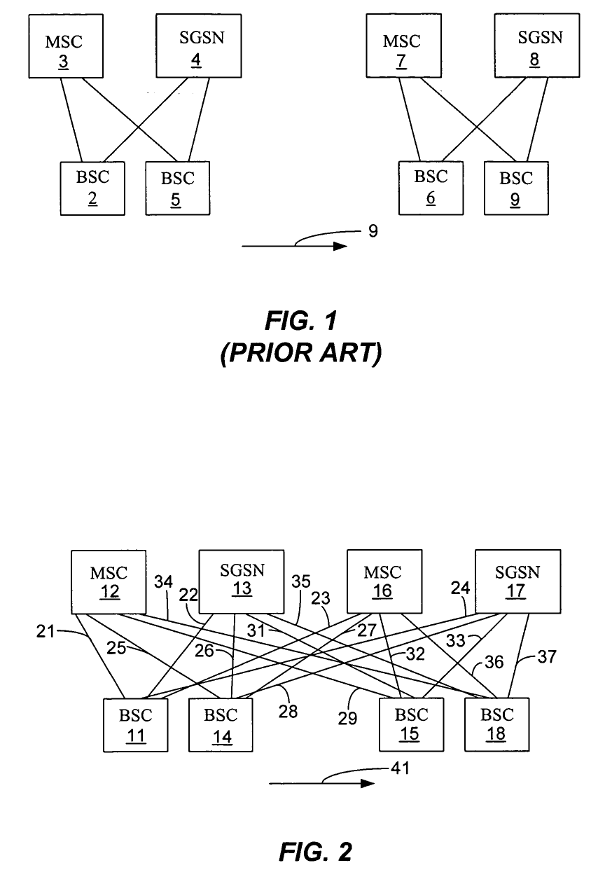

### DETAILED DESCRIPTION OF THE EXEMPLARY EMBODIMENTS

In a wireless network that utilizes pooling, such as a network of the type shown in FIG. 2, for example, the potential for a problem exists as to how to test a node. For example, when a node such as an MSC or SGSN has been taken offline to receive a software upgrade, the node needs to be tested to determine whether the upgrade was successful. Also, it is desirable to test the node without affecting live traffic. When a node is brought back into service and added to the distribution/scheduling algorithm of the BSCs, then live traffic will begin being routed to the node in accordance with load balancing criteria. Consequently, it may be difficult to guarantee that the call tester's calls will be routed to the upgraded node because the tester's call may instead be routed to a node other than the node that was upgraded.

The present invention ensures that a tester's call for testing a MSC or SGSN when it is brought back on line will be routed to the proper MSC or SGSN to be tested. In accordance with one embodiment, a call from a tester is identified by the by comparing, for example, the international mobile subscriber identity (IMSI) or temporary mobile subscriber identity (IMSI) associated with the call with a list of IMSIs or TMSIs. If a match occurs, the BSC determines that the call is from a tester and causes the call to be routed to the MSC or SGSN being tested. In accordance with another embodiment, the location from which the tester's call is placed ensures that the tester's call will be routed to the MSC or SGSN that needs testing.

In accordance with one exemplary embodiment of the invention, the international mobile subscriber identity (IMSI) of the tester's mobile device is used to route the tester's call to the node to be tested. The IMSI is a unique number that is associated with all global system for mobile communications (GSM) networks and universal mobile telecommunications system (UMTS) networks mobile phone users. The IMSI is stored in the subscriber identity module (SIM) smart card. It is sent by the mobile device to the network and is used to lookup the other information associated with the mobile device that is stored in the home location register (HLR) or as locally copied in the visitors location register (VLR).

The IMSI can be up to fifteen digits long. The first three digits are the country code. The next digits are the mobile network code (MNC), which can be either two digits long, as in Europe, or three digits long, as in North America. The remaining digits are the unique mobile subscriber identity number (MSIN) within the network's customer base.

In current wireless networks, in order to avoid the subscriber being identified and tracked, the IMSI of the user's moble device is sent as rarely as possible. Instead, a randomly generated temporary mobile subscriber identity (TMSI) is used by the network to coordinate communications between the mobile device and the BSC.

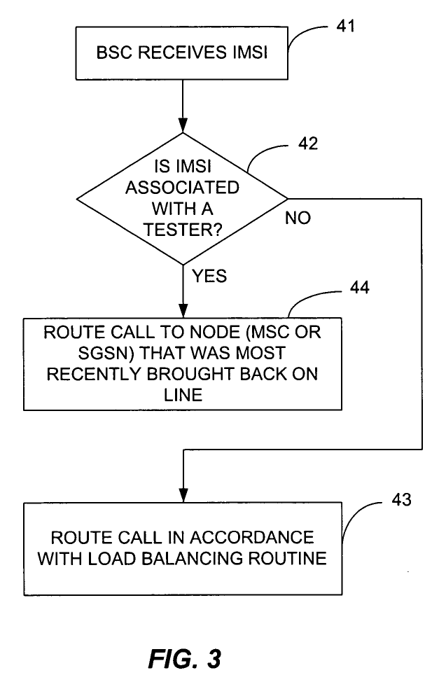

FIG. 3 illustrates a flow chart that represents the method of the invention in accordance with one exemplary embodiment for testing a node when it is brought back on line. In accordance with this embodiment, when a tester wishes to test a node, the tester's mobile device forwards its IMSI to the BSC. The BSC receives the IMSI, as indicated by block 41. The BSC then determines whether the received IMSI is associated with a tester, as indicated by block 42. This may be accomplished by, for example, comparing the IMSI to a list of IMSIs associated with testers to determine whether the received IMSI, or the tester associated with the IMSI, is on the list.

If the BSC determines that the IMSI is not associated with a tester, the call is distributed by the BSC in accordance with a load balancing algorithm to the most appropriate MSC or SGSN, as indicated by block 43. The load balancing algorithm is typically part of the distribution/scheduling algorithm.

If the BSC determines that the received IMSI is associated with a tester, the BSC routes all communications associated with the IMSI to the MSC or SGSN that was brought back on line most recently, as indicated by block 44. The BSCs monitor the status of the MSCs and SGSNs to which they are connected and maintain status information, such as, for example, when a particular node went off line and when it was brought back on line. Therefore, the BSC typically has information that indicates which node is being tested, or this information can be manually provisioned. The BSC uses this information to route the tester's call accordingly. All other traffic is distributed by the BSC among the other MSCs and SGSNs to which BSC is connected in a manner that achieves load balancing.

As an alternative to using the IMSI to identify the tester, the TMSI assigned to the tester's mobile device or some other identifier or code (e.g., the MSIN or MSISDN) could be used for this purpose. The invention is not limited with respect to how the network identifies the tester or the tester's mobile device.

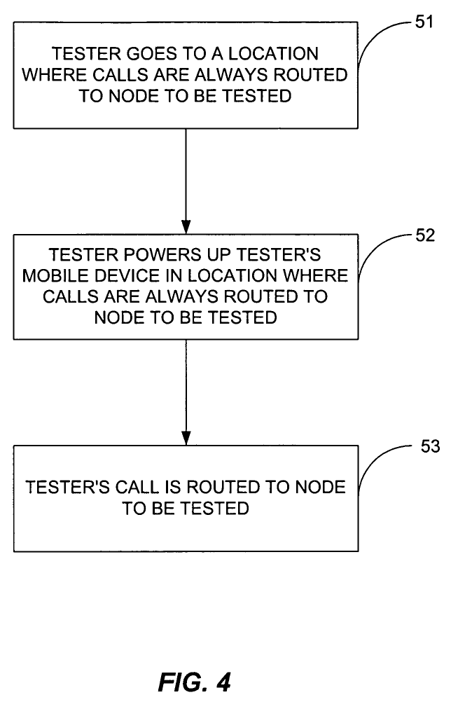

In accordance with another exemplary embodiment, the tester's call is routed based on the area from which the tester's call is made. For example, the tester's call may be routed based on the base transceiver station (BTS), the cellor sector serving the area in which a call from the tester's mobile device is made. FIG. 4 illustrates a flow chart that represents the method of the invention in accordance with this embodiment. When a node that was previously off line is brought back on line, a request to test the node is transmitted to a tester, which is typically a field engineer responsible for performing such tasks. The request may be made, for example, by a network administrator who pages the field engineer and tells the tester which node needs testing. The tester then physically goes to a location that is served by a BTS, cell or sector that always routes calls to the particular node to be tested, as indicated by block 51.

For example, even in a pooling network configuration of the type described above with reference to FIG. 2, the network may be configured such that all calls being served by particular BTSs are always be routed to particular MSCs and to particular SGSNs. Once the tester is physically located in the proper area, the tester powers up the tester's mobile device, as indicated by block 52. The tester's call will then be routed to the node to be tested, as indicated by block 53.

Rather than a network administrator manually paging a tester (e.g., a field engineer who performs tests), the network could automatically send out a request to a tester who is currently in, or close to, the BTS, cell or sector that will route calls to the node to be tested. This might prevent the need to have a tester physically move to a location served by a BTS, cell or sector that will route calls to the node to be tested.

The invention has been described with respect to a few exemplary embodiments. It will be understood by those skilled in the art that the invention is not limited to the exemplary embodiments described herein. For example, although the invention has been described with respect to using particular identifiers (e.g., the IMSI, TMSI, MSIN or MSISDN) to identify a call as being associated with a tester, other identifiers may be used for this purpose. Other modifications can be made to the embodiments described herein and all such modifications are within the scope of the invention.

What is claimed is:

1. An apparatus for testing a node in a wireless network, the network comprising:
at least two mobile services switching centers (MSCs); and
at least one base station controller (BSC) connected to both of the MSCs such that calls serviced by the BSC can be routed to and from either or both of the MSCs;
the apparatus comprising:
logic in the BSC configured to determine whether or not a call being served by the BSC is from a tester, wherein if the logic determines that the call is from a tester, the logic causes the BSC to route the call from the tester to a particular one of the MSCs for testing of the particular MSC.

2. The apparatus of claim 1, wherein the logic makes the determination as to whether a call is from a tester by comparing an international mobile subscriber identity (IMSI) associated with a mobile device of the tester with a list of international mobile subscriber identities (IMSIs), and wherein if the IMSI of the tester's mobile device matches an IMSI on the list of IMSIs, the logic determines that the call is from a tester and causes the call to be routed to said particular MSC.

3. The apparatus of claim 1, wherein the logic makes the determination as to whether a call is from a tester by comparing a temporary mobile subscriber identity (TMSI) associated with a mobile device of the tester with a list of temporary mobile subscriber identities (TMSIs), and wherein if the TMSI of the tester's mobile device matches a TMSI on the list of TMSIs, the logic determines that the call is from a tester and causes the BSC to route the call to said particular MSC.

4. The apparatus of claim 1, wherein if the logic makes a determination that a call is from a tester, the logic identifies one of the MSCs as needing testing and causes the BSC to route the tester's call to the MSC identified as needing to be tested, said MSC identified corresponding to said particular one of the MSCs.

5. An apparatus for testing a node in a wireless network, the network comprising:
at least two serving global packet radio service (GPRS) support nodes (SGSNs), wherein the two BSCs are connected to both of the SGSNs such that calls serviced by each BSC can be routed to and from either or both of the SGSNs; and
at least one base station controller (BSC) connected to both of the SGSNs such that calls serviced by the BSC can be routed to and from either or both of the SGSNs;
the apparatus comprising:
logic in the BSC configured to determine whether or not a call being served by the BSC is from a tester, wherein if said logic determines that the call is from a tester, said logic causes the BSC to route the call from the tester to a particular one of the SGSNs for testing the particular one of the SGSNs.

6. The apparatus of claim 5, wherein the logic makes the determination as to whether a call is from a tester by comparing an international mobile subscriber identity (IMSI) associated with a mobile device of the tester with a list of international mobile subscriber identities (IMSIs), and wherein if the IMSI of the tester's mobile device matches an IMSI on the list of IMSIs, the logic determines that the call is from a tester and causes the BSC to route the call to said particular one of the SGSNs.

7. The apparatus of claim 5, wherein the logic makes the determination as to whether a call is from a tester by comparing a temporary mobile subscriber identity (TMSI) associated with a mobile device of the tester with a list of temporary mobile subscriber identities (TMSIs), and wherein if the TMSI of the tester's mobile device matches a TMSI on the list of TMSIs, the logic determines that the call is from a tester and causes the the BSC to route the call to said particular one of the SGSNs.

8. The apparatus of claim 5, wherein if the logic makes a determination that a call is from a tester, the logic identifies one of the SGSNs as needing to be tested and causes the BSC to route the tester's call to the particular SGSN identified as needing to be tested, said particular SGSN identified corresponding to said particular one of the SGSNs.

9. A method for testing nodes of a network comprising:
receiving calls in a base station controller (BSC);
identifying one of the calls as a test call; and
routing the test call to a mobile services switching center (MSC) to be tested.

10. The method of claim 9, wherein the BSC identifies a call as a test call by comparing an international mobile subscriber identity (IMSI) associated with a call with a list of international mobile subscriber identities (IMSIs), and wherein if the IMSI associated with a call matches an IMSI on the list of IMSIs, the BSC determines that the call is a test call and causes the test call to be routed to said MSC.

11. The method of claim 9, wherein the BSC identifies a call as a test call by comparing a temporary mobile subscriber identity (TMSI) associated with a call with a list of temporary mobile subscriber identities (TMSIs), and wherein if the TMSI associated with a call matches a TMSI on the list of TMSIs, the BSC determines that the call is a test call and causes the test call to be routed to said particular MSC.

12. The method of claim 9, wherein if the BSC identifies a call as being a test call, the BSC identifies an MSC that needs to be tested and causes the test call to be routed to the MSC identified as needing to be tested.

13. A method for testing nodes of a network comprising:
receiving calls in a base station controller (BSC);
identifying one of the calls as a test call; and
routing the test call to a serving global packet radio service (GPRS) support node (SGSN) to be tested.

14. The method of claim 13, wherein the BSC identifies a call as a test call by comparing an international mobile subscriber identity (IMSI) associated with a call with a list of international mobile subscriber identities (IMSIs), and wherein if the IMSI associated with a call matches an IMSI on the list of IMSIs, the BSC determines that the call is a test call and causes the test call to be routed to said SGSN.

15. The method of claim 13, wherein the BSC identifies a call as a test call by comparing a temporary mobile subscriber identity (TMSI) associated with a call with a list of temporary mobile subscriber identities (TMSIs), and wherein if the TMSI associated with a call matches a TMSI on the list of TMSIs, the BSC determines that the call is a test call and causes the test call to be routed to said SGSN.

16. The method of claim 13, wherein if the BSC identifies a call as being a test call, the BSC identifies an SGSN that needs to be tested and causes the test call to be routed to the SGSN identified as needing to be tested.
